(19) United States
(12) Patent Application Publication
(10) Pub. No.: US 2005/0285310 A1
(43) Pub. Date: Dec. 29, 2005

(54) THIN WALL INJECTION WITH IN-MOLD DISPLACEMENT

(75) Inventors: David Nagi, Saline, MI (US); Nelson Williams, Saline, MI (US)

Correspondence Address: JOHN A. ARTZ, ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 10/710,259

(22) Filed: Jun. 29, 2004

(51) Int. Cl. B29C 45/00

(52) U.S. Cl. 264/328.7; 425/555

(57) ABSTRACT

A method and system for providing plastic injection molded parts with thin wall sections or portions. The mold has one or more plunger or piston members which operate to reduce the size of the mold cavity and thus the thickness of wall sections or portions of the molded parts, preferably at 70-75% or more of their surface area. Commercially acceptable parts with wall thicknesses on the order of 2.5 mm can be provided with the present invention.

### BACKGROUND OF INVENTION

The present invention relates to the injection molding of plastic products, particularly thin walled plastic products.

The manufacture of plastic products and components by injection molding techniques is common today. Plastic products and plastic components constitute a major part of numerous consumer products in common use, including houseware products, components for vehicles, sports and leisure products, and the like. The large size of many components, however, as well as complex exterior configurations, often causes difficulties in the injection molding process. Common problems include warpage, shrinkage, non-uniform color, sink marks, and knit line issues.

Also, in efforts to reduce material costs and increase production, particularly relative to plastic products which are made in large quantities, efforts have been made to reduce the wall thicknesses wherever possible. Thinner walls result in the use of less plastic material which can result in significant savings. Material costs are often the largest part of the cost of plastic injection molded parts and components. Also, the thinner the plastic parts, the faster the cooling time and thus the faster the cycle time. This results in increased production over a given time period, also resulting in decreased manufacturing costs.

The efforts to reduce the thickness of walls and other portions of plastic injection molded components, however, have often not been satisfactory. One or more of the common problems mentioned above often result from these attempts. Thus, there is a need for improved manufacturing and processing techniques in the plastic injection molding field for producing parts and components which have thin wall sections, as well as a need for an improved process and system for creating thinner wall sections on existing plastic products.

### SUMMARY OF INVENTION

It is an object of the present invention to provide an improved process and system for the manufacture of plastic injection molded parts and components. It is another object of the present invention to provide a commercially acceptable plastic injection molded manufacturing process and system which can produce products or portions of products which have thinner walls.

It is a further object of the present invention to provide an improved plastic injection molding process and system which reduces the expense of existing processes and systems. It is an additional object of the present invention to provide a plastic injection molding process and system which has improved efficiency and economy.

It is a still further object of the present invention to provide a plastic injection molding process and system which creates thin-walled parts and components without experiencing the common problems which typically affect such processes and systems.

These objects are achieved by the present invention which overcomes the problems commonly experienced with present systems and processes which attempt to manufacture plastic injection molded parts with thin wall sections. In accordance with a preferred embodiment of the invention, a mold is provided with a cavity in the size and shape of the final product. A moveable plunger or piston member is provided in one of the mold halves and operated to narrow the plastic part at substantial portions of its area. Preferably, the molded product has a thinner wall portion over 70-75% or more of its total surface area.

In alternate embodiments, two or more piston members could be provided which could form thin areas in separate or contiguous areas. In addition, opposed piston members in both halves of the mold could be provided.

### BRIEF DESCRIPTION OF DRAWINGS

FIG. 1 is a schematic drawing of a door panel which can be made with the present invention.

FIG. 2 is a cross-section taken along line 2-2 in FIG. 1 and in the direction of the arrows.

FIG. 3 is a schematic diagram illustrating an embodiment of the present invention.

FIG. 4 is a schematic diagram illustrating a step in the process in the use of an embodiment of the present invention.

FIG. 5 is a schematic diagram illustrating another embodiment of the present invention.

FIG. 6 is a flow diagram illustrating the basic steps of a process utilizing one embodiment of the present invention.

FIG. 7 illustrates a possible use of the present invention for an actual door panel.

FIGS. 8 and 9 disclose alternate embodiments of the invention.

### DETAILED DESCRIPTION

The present invention has particular use in providing thin wall sections or portions of plastic injection molding products. The manufacture of plastic parts and components is in common use today and significant savings can be created, particularly in large volume production, if the walls or portions of the products can be made thinner, thus utilizing less plastic material and decreasing the cycle time. The cost of the plastic material is often one of the largest costs, if not the largest cost, in the production of plastic parts and components. For example, a savings and material cost on the order of 10 cents per part relative to parts which are produced on the order of several hundred thousand a year could result in a savings of over a million dollars a year alone, simply by reducing the thickness of one or more portions of the parts.

One preferred use of the present invention is in the production of plastic interior door panels for automobiles and other vehicles. A schematic diagram of an interior door panel of that type is shown schematically in FIG. 1 and indicated generally by the reference numeral 10. It is apparent, however, that the present invention can be used with any type of component or product which is manufactured using plastic injection molding techniques and is not limited to door panels or other components for the automobile industry.

Also, the preferred plastic material for producing interior door panels today is polypropylene. The present invention thus has particular use with the manufacture of plastic parts and components from that material. However, it is also to be understood that the present invention is not limited to the use of polypropylene, but can be used with all types and kinds of plastic materials which are in use today.

In the door panel 10 shown in FIG. 1, the area or portion which is to be manufactured having a thinner wall section or sections is indicated by the reference numeral 12. The remainder of the door panel which has a thicker wall thickness is indicated by the reference numeral 14. The reference numerals 16 and 18 refer to areas in the door panel which are used for arm rests, door latches, window latches, and the like.

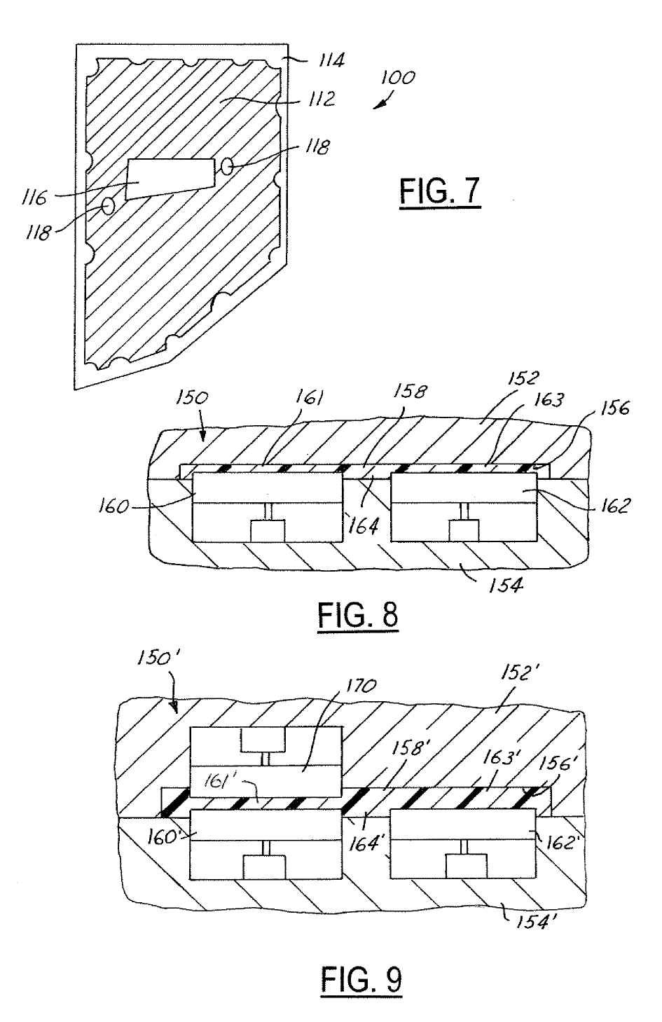

Also, the thin wall area 12, as shown in FIG. 1, is only shown schematically in relative size. In actual production, the portion of the door panel or other product which can have a thin wall portion in accordance with the present invention can be 70-75 percent or more of the total surface area of the part or component. In this regard, a proposed thin wall area 112 on the outline of an actual door panel 100 is shown in FIG. 7. Also indicated in FIG. 7 are the remaining original thickness areas 114 of the door panel, along with thicker areas for an arm rest 116 and door latches 118.

FIG. 2 is a cross-section of the schematic door panel 10 as shown in FIG. 1. The door panel in FIG. 2 has a thickness T1 in the thicker areas and a thickness T2 in the thinner areas 12. In some door panels manufactured today, the thickness T1 is on the order of 3 millimeters, while with the present invention, the thinner area 12 having dimension T2 is preferably 2.5 millimeters or less.

Using present techniques for attempting to reduce the portions of plastic products to make wall sections or portions on the order of 2.5 millimeters thickness or less, the processes typically cause significant stress in the parts making them commercially unacceptable for large scale production. Also, these attempts have created color issues in the manufactured parts, with the color not being uniform throughout. Further, the knit lines where the injected plastic flows meet within the mold cavity have not been of sufficient commercial quality. Areas in which knit lines are often unacceptable with present commercial products are indicated by the reference letter A in FIG. 1.

With use of the present invention, the plastic parts and components are also lighter in weight, making them easier to handle, both manually and automatically, in the production process. Also, portions of the thinner areas 12 in the door panel can be covered with carpeting or other decorative trim and components.

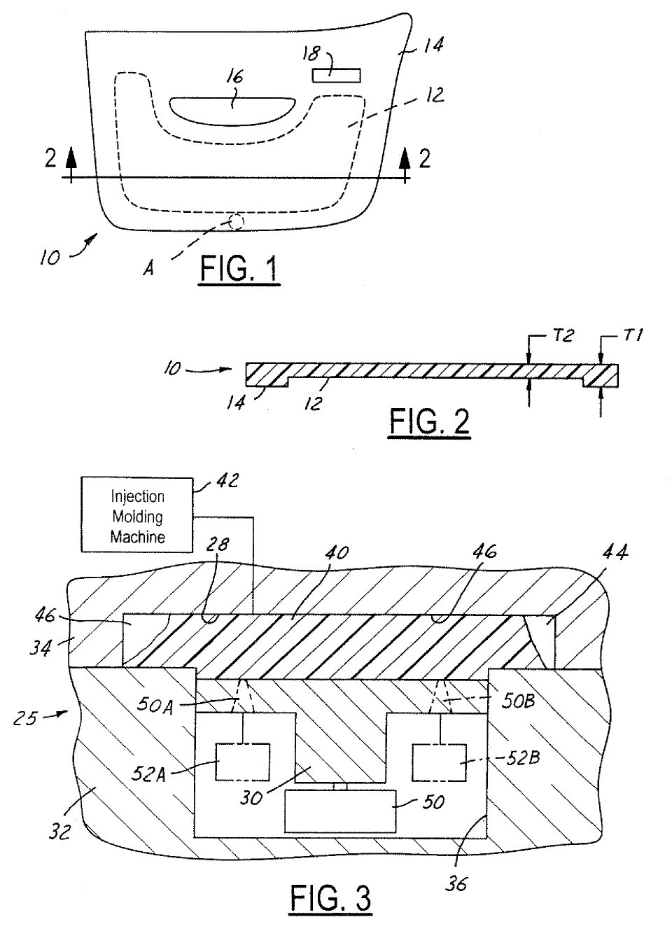

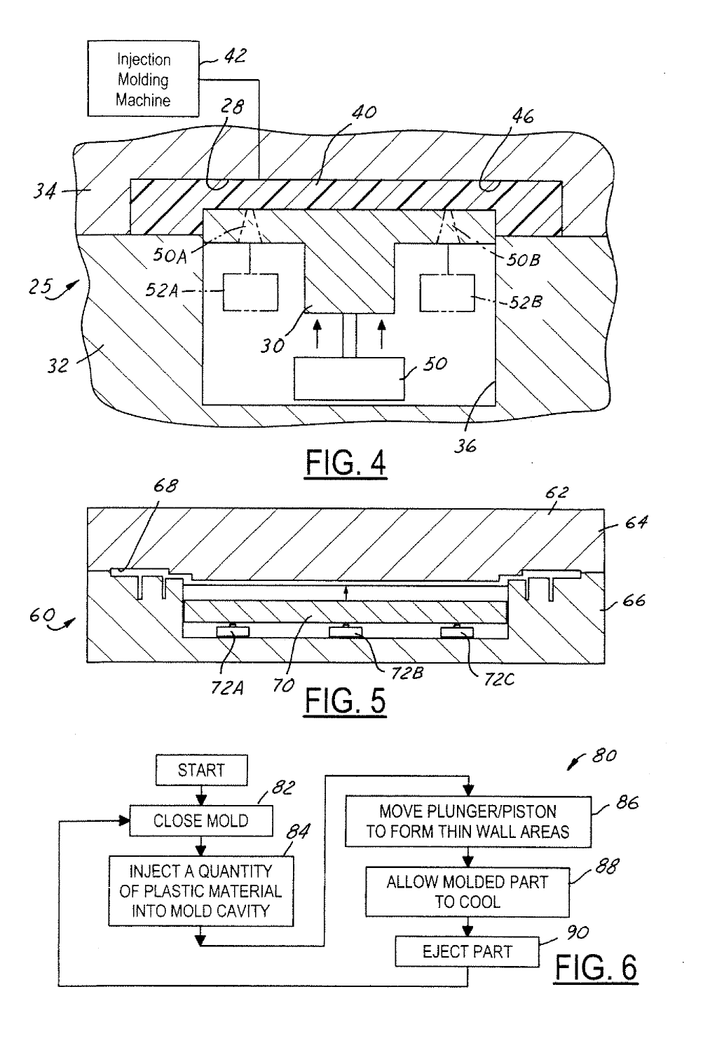

Two of the steps in the process according to a preferred embodiment of the present invention are shown in FIGS. 3 and 4. In this embodiment, a plunger or piston member 30 is positioned in the mold cavity member 32 of a mold 25. The mold cavity 28 in which the plastic part or component is formed is positioned in the mold core member 34 of the mold 25. The walls of the mold cavity 28, such as wall 46, are typically textured in order to provide an aesthetic textured surface to the final molded part.

As shown in FIG. 3, the piston member 30 is in its retracted position in a bore or cavity 36 when the injection molding process is initiated. Plastic material 40 is injected into the mold cavity from an injection molding machine which is schematically shown by Box No. 42. Also as shown in FIG. 3, less than 100 percent of the mold cavity 28 is filled with plastic material during the plastic injection process. (This is commonly called a “short shot” process.) This leaves areas which are schematically shown by reference numerals 44 and 46 as voids to be filled later in the process by movement of the plunger 30.

The location for the injection of the plastic material into the mold cavity is typically a matter of choice to the molder or mold maker. For example, the plastic material could also be injected into the mold cavity through sprue areas 50A and/or 50B from sources 52A and/or 52B, respectively, as shown in phantom lines in FIG. 3. The plastic material could also be injected into the mold cavity 28 through the mold cavity member 32 (not shown) rather than the mold core member 34 as shown in FIG. 3. Another possible injection site for the plastic material would be to locate the sprue in a non-moveable area of the part, such as the area 18.

Once the requisite quantity of plastic material has been injected into the mold cavity, or substantially injected into the mold cavity, the piston or plunger member 30 is moved to the position as shown in FIG. 4. Movement of the plunger 30 can be done in any conventional manner, such as with a hydraulic, pneumatic, electrical system, mechanically by the press, or the like. In this regard, the mechanism for movement of the plunger or piston member 30 is shown schematically by reference numeral 50 in FIGS. 3 and 4.

Movement of the plunger member 30 to the position shown in FIG. 4 fills out the mold cavity 28 completely with plastic material and also packs the plastic material in the mold cavity. The plastic material can also be packed in the mold by conventional methods.

It is to be understood that the degree of movement of the plunger/piston member 30 in FIGS. 3 and 4 is only shown schematically. In actual practice, the amount of movement of the plunger member is typically on the order of 0.5-0.7 millimeters. In this regard, as mentioned above, a decrease in the thickness of an interior door panel component for an automobile or other vehicle from 3 millimeters to 2.5 millimeters can create a substantial savings in material cost when it is considered that hundreds of thousands of door panels can be produced on an annual basis utilizing this process.

Another embodiment illustrating use of the present invention is shown in FIG. 5. This embodiment is referred to generally by the reference numeral 60. The mold 62 has a core mold member 64 and a cavity mold member 66. The mold cavity in which the part is formed is referred to as reference numeral 68. The piston or plunger member 70 is positioned in the mold cavity member 66 and is illustrated as being operated by a plurality of actuation members 72A, 72B and 72C. The movement of the piston member 70 is the same as the movement of the piston member 30 as described above, with similar actuation mechanisms and results.

Although the embodiments shown herein utilize a plunger or piston member to form the thin wall sections, it is also possible within the scope of the invention to use other mechanisms for accomplishing that same result, such as a molding press.

FIG. 6 is a flow diagram setting forth the primary steps in a process in accordance with the present invention. The process is generally indicated by the reference numeral 80. Once the mold is closed, 82, a quantity of plastic material is injected into the mold cavity. This is shown in Box 84. As indicated above, the quantity of plastic material is less than the 100 percent necessary to fill the entire mold cavity, with the amount being determined on a case-by-case basis. Thereafter, once the quantity of plastic material has been injected into the mold cavity, or when substantially all of the plastic material has been injected into the mold cavity, the plunger/piston member is moved from its rest position in order to form the thin wall portions or areas of the product. This is shown in Box 86. In this regard, although it is possible to move the plunger/piston member prior to completion of the injection of the plastic material, it is preferred to first inject all of the requisite quantity of plastic material into the mold cavity before the plunger member is moved. It is also possible to have a slight delay, or a predetermined time delay, following injection of the plastic material into the mold cavity before the plunger/piston member is moved from its rest position.

It is also possible to vary the speed of the movement of the plunger/piston member in the mold. The speed of the movement of the plunger/piston member can be dependent upon many factors, including the type of plastic material utilized, the time delay between injection of the plastic material and movement of the piston member, and the resultant commercial quality of the resultant parts or components. The speed of the plunger/piston member can be determined on a case-by-case basis.

Thereafter, the plastic material forming the molded part is allowed to cool and solidify sufficiently in order for the part to be ejected from the mold cavity. This is shown in Box 88. Thereafter, the mold is opened and the part is ejected 90. The ejection is typically aided by the use of one or more ejector pins (not shown). Subsequently, the mold is closed and the cycle is repeated.

In alternate embodiments, two or more plunger members could be provided in the mold. The plunger or piston members could be positioned in the mold in order to provide thinner wall sections at separated or contiguous areas. Plunger or piston members could also be positioned in both mold halves which could provide thinner wall sections in separate areas or in the same area opposed to one another. Any combinations of plunger or piston members in the same and/or opposed mold halves could be provided.

Examples of some of these alternate embodiments are shown in FIGS. 8 and 9. In FIG. 8, the mold 150 has two mold members 152 and 154. The mold cavity 156 is formed in one of the mold members in the shape of the plastic part to be produced. The injection of plastic material 158, which preferably is a short shot, fills or substantially fills the mold cavity 156. A plurality of piston members 160, 162 (only two of which are shown for illustrative purposes) are utilized to thin out the plastic material in areas or sections 161 and 163 in the mold cavity. The operation of piston members 160, 162 is the same as the operation of piston members 50 and 72A-C described above. This embodiment could be utilized, for example, where it is mechanically or physically difficult to provide a single piston member to cover all of the areas to be thinned out, or where it is necessary to maintain a thicker area (such as area 164) to act as a stiffening rib or the like on the part.

In FIG. 9, another piston member 170 is provided which is positioned in an opposed relationship to one of the other piston members (such as piston member 160′) in the opposite mold member. This embodiment provides a plastic part which has a thinner area 161′ which is slightly recessed on both sides of the part.

While the invention has been described in connection with one or more embodiments, it is to be understood that the specific mechanisms, processes and procedures which have been described are merely illustrative of the principles of the invention, numerous modifications may be made to the methods and apparatus described without departing from the spirit and scope of the invention as defined by the appended claims.

1. A method for plastic injection molding comprising:
providing a mold cavity to form a plastic molded part with a predetermined surface area;
injecting a quantity of plastic material into said mold cavity;
reducing the cross section of the mold cavity at least at 50% of the surface area;
allowing the plastic material to cool in the mold cavity;
and
ejecting the molded part from the mold cavity,
wherein the molded part has thin walled sections at least at 50% of its surface area.

2. The method as described in claim 1 wherein said cross-section of the mold cavity is reduced by movement of a piston member in the mold cavity.

3. The method as described in claim 1 wherein said cross-section is reduced at least 75% of the surface area.

4. The method as described in claim 1 wherein the quantity of plastic material injected into the mold cavity is less than the full amount to fill the mold cavity.

5. The method as described in claim 4 wherein said step of reducing the cross section of the mold cavity operates to completely fill the mold cavity with plastic material.

6. The method as described in claim 1 wherein said cross-section of the mold cavity is reduced by movement of at least two piston members in the mold cavity.

7. The method as described in claim 6 wherein said at least two piston members are positioned in the same side of the mold cavity.

8. The method as described in claim 6 wherein at least two of said piston members are positioned opposed to one another in said mold cavity.

9. The method as described in claim 1 further comprising the step of ejecting the molded part comprises opening the mold and removing the molded part.

10. The method as described in claim 1 in which the cross-section of the mold cavity is reduced to provide a molded plastic part with a wall thickness of less than about 3 mm in the reduced cross-section areas.

11. The method as described in claim 10 wherein the wall thickness is reduced to about 2.5 mm.

12. A method for the formation of plastic molded parts having thin wall sections over at least 50% of the surface area of the parts, said method comprising:
providing a mold with a mold cavity;
providing at least one moveable member in said mold, said moveable member being positioned to reduce the volume of the mold cavity;
injecting a quantity of plastic material into the mold cavity; and
actuating the moveable member to reduce the volume of the mold cavity to form thin wall sections in the molded part.

13. The method as described in claim 12 further comprising the steps of allowing the plastic material to cool, opening the mold, and removing the plastic molded part from the mold cavity.

14. The method as described in claim 12 wherein said quantity of plastic material is less than an amount necessary to completely fill the mold cavity.

15. The method as described in claim 12 wherein the volume of the mold cavity is reduced to form wall sections in the molded part of less than about 3 mm.

16. The method as described in claim 15 wherein the wall section are about 2.5 mm in thickness.

17. A system for injection molding a plastic part comprising:
a mold with a mold cavity;
at least one moveable member situated in said mold and positioned to reduce the volume of the mold cavity.

18. The system as described in claim 17 wherein said moveable member is actuated by a system from the group consisting of electronic, hydraulic and pneumatic.

19. The system as described in claim 17 wherein at least two moveable members are provided in said mold and utilized to reduce the volume of the mold cavity.

20. The system as described in claim 17 wherein the plastic part to be injection molded has a large surface area and the reducing of the volume of the mold cavity reduces the thickness of the walls of the plastic part over 50% of the surface area.
